(19) United States
(12) Patent Application Publication
(10) Pub. No.: US 2026/0335195 A1
(43) Pub. Date: Oct. 29, 2026

(54) MOUTHPIECE

(71) Applicant: EIGHTBEES CORPORATION, Onojo-shi, Fukuoka (JP)

(72) Inventor: Satoru BABA, Onojo-shi, Fukuoka (JP)

(21) Appl. No.: 19/120,473

(22) PCT Filed: Oct. 11, 2023
(86) PCT No.: PCT/JP2023/036913

§ 371 Date: Apr. 11, 2025

(30) Foreign Application Priority Data
Oct. 12, 2022 (JP) 2022-164322

(51) Int. Cl. A61J 17/00

(52) U.S. Cl. CPC A61J 17/10

(57) ABSTRACT

A mouthpiece includes, in a state of being fitted in an oral cavity, a base that is formed so as to be curved, from a central portion at a front side, toward respective end portions at a rear side, and that is arrangeable at a position sandwiched between upper and lower gingiva or teeth, and a cheek stimulator that is formed so as to protrude in an up-and-down direction at a position surrounding an outer side of the base and in which a protrusion height of a central portion is smaller than a protrusion height of respective end portions.

### TECHNICAL FIELD

The present disclosure relates to a mouthpiece.

### BACKGROUND ART

Japanese Patent Application Laid-Open (JP-A) No. 2010-208239 discloses an oral training device for training a person's tongue and lips. The oral training device is provided with outer walls located on a face side and a cheek side of a dental arch. This protects teeth. A tongue training member for training a tongue position is formed in the oral training device. A user can learn a correct swallowing pattern by using the oral training device.

### SUMMARY OF INVENTION

### Technical Problem

The oral training device disclosed in JP-A No. 2010-208239 is intended for a user having teeth to be occluded. Although development of oral functions depends on presence or absence of training in infants and young children and a quality of training, there has been conventionally no training device capable of developing oral functions of infants and young children.

In view of these facts, the disclosure mainly develops the oral functions of infants and young children.

### Solution to Problem

A mouthpiece according to a first aspect includes, in a state of being fitted in an oral cavity, a base that is formed so as to be curved from a central portion at a front side, toward respective end portions at a rear side, and that is arrangeable at a position sandwiched between upper and lower gingiva or teeth, and a cheek stimulator that is formed so as to protrude in an up-and-down direction at a position surrounding an outer side of the base and in which a protrusion height of a central portion is smaller than a protrusion height of respective end portions.

In the mouthpiece according to the first aspect, the base is arranged at a position sandwiched between the upper and lower gingiva or teeth in a posture of being fitted in the oral cavity. The cheek stimulator protruding in the up-and-down direction is arranged at a position surrounding the outside of the base.

In a case in which, for example, the mouthpiece is fitted in the oral cavity of an infant or a young child, therefore, the cheek stimulator comes into contact with an inside of the cheeks of the infant or the young child. As a result, the inside of the cheeks is stimulated, and movement of the cheeks is promoted. Consequently, it is possible to promote thinning of Bichat's fat pad seen in infants and young children and to increase oral cavity volume.

In the cheek stimulator, a protrusion height of a central portion is smaller than a protrusion height of the end portions. In the cheek stimulator surrounding the outside of the base, the central portion is a portion that interferes with the lips of the infant or the young child. For infants and young children, movement of the upper lip is generally more difficult than movement of the lower lip. By reducing the upward protrusion height of the central portion, the interference between the cheek stimulator and the upper lip is suppressed, and a motion of closing the upper lip is promoted to develop the muscle. Consequently, development of oral functions (for example, a function of eating with the mouth closed and a function of pronouncing sounds correctly) during growth can be promoted. As a result, for example, favorable alignment of teeth can be promoted.

The oral functions of infants and young children can thus be mainly developed by using the mouthpiece.

A mouthpiece for infants according to a second aspect is the mouthpiece according to the first aspect, in which a tongue rest, which protrudes downward and rearward and has a curved upper surface recessed downward toward the rear side, is formed behind the base.

In the mouthpiece according to the second aspect, the tongue rest is formed behind the base. The tongue rest has a curved upper surface which is recessed downward toward the rear. Infants and young children are often not good at a motion of raising the tongue, but in a case in which the tongue comes into contact with the tongue rest having such a shape, the tongue tends to warp upward. The motion of raising the tongue, therefore, is supported. That is, with the mouthpiece, not only the motion of the cheeks of the infant or the young child but also the motion of the tongue are promoted. As a result, secretion of saliva is promoted. A function of eating and a function of speaking are also improved.

A mouthpiece according to a third aspect is the mouthpiece according to the second aspect, in which a groove, formed toward a front side from a rear end and penetrating in the up-and-down direction, is provided at a central portion of the tongue rest in a width direction.

In the mouthpiece according to the third aspect, the groove penetrating in the up-and-down direction is formed in the central portion of the tongue rest. The tongue tie, therefore, is easily accommodated in the groove. By moving the tongue with the tongue tie in contact with the groove wall, the tongue tie is extended to increase length of the tongue tie, and development of the tongue tie is promoted. Consequently, a range of motion of the tongue increases, and the oral functions such as pronunciation, chewing, swallowing, and respiration are improved.

A mouthpiece according to a fourth aspect is the mouthpiece according to the first aspect, in which the base and the cheek stimulator are formed of a flexible material.

In the mouthpiece according to the fourth aspect, since the base and the cheek stimulator are formed of the flexible material, the base and the cheek stimulator can be elastically deformed in a case in which the base and the cheek stimulator come into contact with the gingiva or the inside of the teeth or the cheeks. As a result, the upper and lower gingiva and the cheeks hardly become painful.

In the case in which the base and the cheek stimulator are elastically deformed, the base and the cheek stimulator attempt to return to original shapes thereof, and stimulation is given to the inside of the cheeks to promote movement of the cheeks. As a result, the effect of promoting the thinning of Bichat's fat pad is enhanced.

A mouthpiece according to a fifth aspect is the mouthpiece according to the fourth aspect, in which the base has an elastic force directed outward in a width direction.

Since the mouthpiece according to the fifth aspect has the elastic force directed outward in the width direction in the state of being fitted in the oral cavity, stimulation is given to the inside of the cheeks to further promote the motion. It is also possible to increase the oral cavity volume.

A mouthpiece according to a sixth aspect is the mouthpiece according to the first aspect, in which the respective end portions of the base have tapered shapes such that width gradually decreases from the front side toward the rear side.

In the mouthpiece according to the sixth aspect, since the end portions of the base are tapered, the mouthpiece is inserted into the oral cavity from the thin end portions. Compared to a case in which the end portions are not tapered, therefore, it is easy to insert the mouthpiece into the oral cavity.

A mouthpiece according to a seventh aspect is the mouthpiece according to the first aspect, in which a handle protruding outward from the central portion of the base is coupled to the cheek stimulator, and a through hole is formed in the handle.

Since the handle is connected to the mouthpiece for infants according to the seventh aspect, the mouthpiece is easily inserted into and removed from the oral cavity.

Since the through hole is formed in the handle, it is possible to suppress accidental ingestion of the mouthpiece by passing a string.

A mouthpiece for infants according to an eighth aspect is the mouthpiece according to the first aspect, in which a downward protrusion dimension of the cheek stimulator is larger than an upward protrusion dimension of the cheek stimulator.

In the mouthpiece according to the eighth aspect, the downward protrusion dimension of the cheek stimulator is larger than the upward protrusion dimension of the cheek stimulator. The lower jaw of humans moves downward and forward. Since the downward protrusion dimension of the cheek stimulator is larger than the upward protrusion dimension, the state in which the cheek stimulator is in contact with the inside of the cheeks can be maintained even in a case in which the lower jaw moves downward and forward.

A mouthpiece according to a ninth aspect is the mouthpiece according to the first aspect, in which a handle protruding outward from the central portion of the base is connected to the cheek stimulator, and a groove along an outer peripheral surface of the cheek stimulator is formed in an upper surface of a portion of the handle coupled to the cheek stimulator.

In the mouthpiece according to the ninth aspect, a groove 54 is formed in the upper surface of the portion connected to the cheek stimulator in the handle. As a result, a movable range of the upper lip can be increased as compared with a case in which the groove is not provided. As a result, a motion effect of the upper lip can be enhanced.

### Advantageous Effects of Invention

According to the disclosure, it is possible to mainly develop oral functions of infants and young children.

### BRIEF DESCRIPTION OF DRAWINGS

FIG. 1 is a perspective view illustrating a mouthpiece according to an embodiment.

FIG. 2 is a top view illustrating the mouthpiece according to the embodiment.

FIG. 3 is an arrow view taken along line 3-3 in FIG. 2.

### DESCRIPTION OF EMBODIMENTS

A mouthpiece according to an embodiment of the disclosure will be described hereinafter with reference to the drawings. Components denoted by the same reference numerals in each drawing mean the same components. Unless otherwise specified in the specification, however, the number of pieces of each component is not limited to one, and a plurality of pieces of the component may exist.

Description of configurations and reference numerals overlapping between different drawings might be omitted. The disclosure is not limited to the following embodiment, and can be implemented with appropriate modifications, such as omitting a configuration within the scope of the object of the disclosure, replacing with a different configuration, or using one embodiment and various modifications in combination.

In each drawing, directions indicated by arrows X and Y are directions along a horizontal plane and are orthogonal to each other. A direction indicated by an arrow Z is a direction along a vertical direction (up-and-down direction). In each drawing, the directions indicated by the arrows X, Y, and Z coincide with each other.

### Mouthpiece

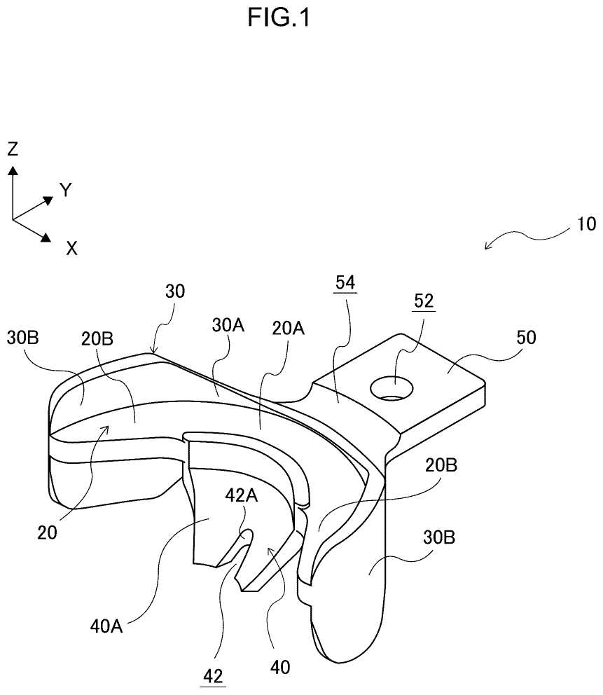

FIGS. 1(A) and 1(B) illustrate a mouthpiece 10 according to the embodiment of the disclosure. The mouthpiece 10 is an oral function training device that aims to develop the oral functions in a period (infancy and early childhood) from about 1 month after birth to about 5 years old before a user mainly has teeth. The mouthpiece 10 can also be used to develop the oral functions of a user of about 5 to 12 years old.

An X direction shown in these drawings is a width direction of the mouthpiece 10, and is a direction substantially coinciding with a width direction of the user's face in a state where the mouthpiece 10 is fitted in the user's oral cavity. A Y direction is a front-and-back direction of the mouthpiece 10, and is a direction substantially coinciding with an anterior-to-posterior direction in the oral cavity in the state where the mouthpiece 10 is fitted in the oral cavity. AZ direction is an up-and-down direction of the mouthpiece 10, and is a direction substantially coinciding with an up-and-down direction of the face in the state where the mouthpiece 10 is fitted in the oral cavity.

The mouthpiece 10 is made of a flexible elastic material (for example, silicone), and includes a base 20, a cheek stimulator 30, a tongue rest 40, and a handle 50. These portions are integrally formed with the same material without seams.

### Base

The base 20 is curved from a front central portion 20A toward each of rear end portions 20B and is formed in a “C shape” in plan view. The base 20 is formed in a plate shape along an XY plane, and is a portion that can be arranged at a position sandwiched between upper and lower gingiva or teeth in the state where the mouthpiece 10 is fitted in the user's oral cavity. The “gingiva” includes gums, alveolar ridges (only infants), and alveolar crests.

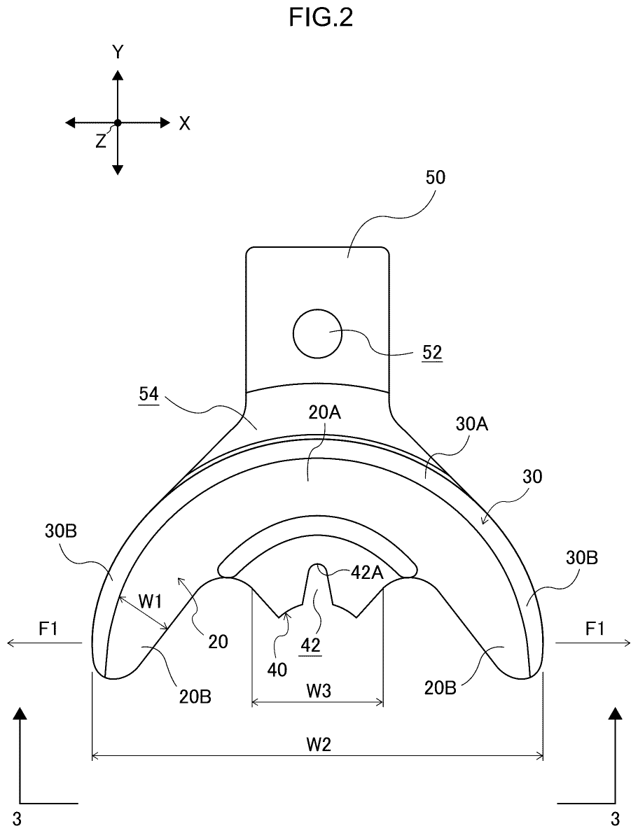

As illustrated in FIG. 2, the end portions 20B of the base 20 have tapered shapes in which width W1 gradually decreases from the front toward the rear (in other words, from a back side to a tip side in a direction of insertion into the oral cavity).

The base 20 has an elastic force directed outward in the width direction (X direction) in the state where the mouthpiece 10 is fitted in the oral cavity. That is, in the state where the mouthpiece 10 is fitted in the oral cavity, the base 20 is pressed from an inside of the user's cheeks and elastically deformed. At this time, an elastic force (a restoring force indicated by an arrow F1) toward the outside in the width direction of the mouthpiece 10 is generated as the mouthpiece 10 attempts to return to an original shape thereof.

Whether or not such an elastic force is generated depends on width of the user's oral cavity. In a case in which the width of the user's oral cavity is smaller than width W2 of the mouthpiece 10, such an elastic force is generated. From this point of view, the width W2 of the mouthpiece 10 is set to a dimension larger than an average value of the width in the oral cavity of infants and young children from 0 to 12 years old.

Target ages of users of the mouthpiece 10 can be subdivided. In this case, for example, the width W2 may be a dimension larger than an average value of the width in the oral cavity of infants from 0 to 1 year old, a dimension larger than an average value of the width in the oral cavity of young children from 3 to 5 years old, a dimension larger than an average value of the width in the oral cavity of children from 5 to 12 years old, or the like. In a case in which a specific country or race is assumed as the user, the width in the oral cavity of an infant, a young children or the like in the country or race can be referred to.

As the “average value”, an average value of the width in the oral cavity of typically developing infants and young children or the like can be employed, but for example, an average value including the width in the oral cavity of non-typically developing infants and young children or the like may be employed, instead. That is, a method of determining the width W2 of the mouthpiece 10 is not particularly limited, and may be appropriately determined in accordance with a demand.

### Cheek Stimulator

As illustrated in FIG. 1, the cheek stimulator 30 is formed at a position surrounding an outside of the base 20 in such a way as to protrude in the up-and-down direction (That is, both upward and downward).

Specifically, the cheek stimulator 30 has a shape along a half cylinder in which the up-and-down direction is a cylinder axis direction, and is arranged in such a way as to surround the outside of the base 20. An outer peripheral surface of the base 20 is connected to an inner peripheral surface of the cheek stimulator 30.

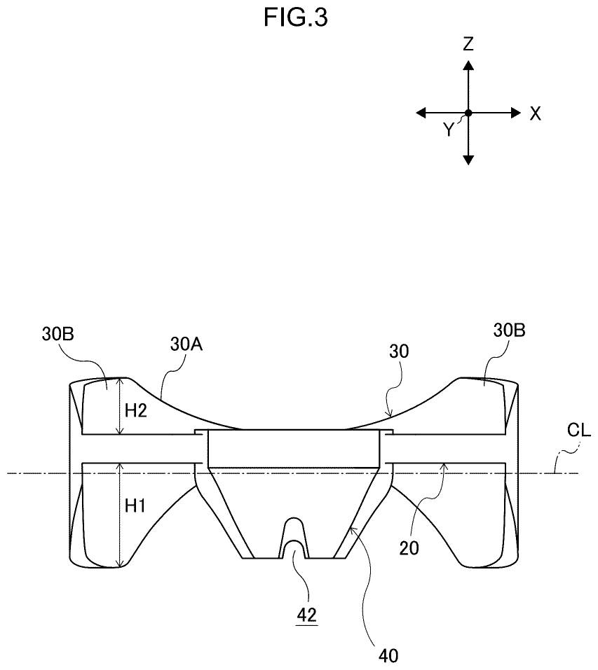

As illustrated in FIG. 3, the base 20 is connected to a portion of the cheek stimulator 30 above a center line CL in the up-and-down direction. As a result, the cheek stimulator 30 is formed in such a way as to protrude in the up-and-down direction of the base 20. In the cheek stimulator 30, a downward protrusion dimension H1 (a protrusion dimension from a lower surface of the base 20) is larger than an upward protrusion dimension H2 (a protrusion dimension from an upper surface of the base 20).

As illustrated in FIG. 1, a protrusion height of a central portion 30A of the cheek stimulator 30 is smaller than a protrusion height of end portions 30B. Specifically, in the cheek stimulator 30, the protrusion height of the end portions 30B in the up-and-down direction is substantially constant. The central portion 30A, which is a portion sandwiched between the end portions 30B, has a shape whose protrusion height gradually decreases from the end portions 30B toward a foremost portion of the cheek stimulator 30. The protrusion height of the foremost portion of the central portion 30A is substantially zero.

The end portions 20B of the base 20 and the end portions 30B of the cheek stimulator 30 can be cut using, for example, scissors or a cutter. As a result, sizes of the base 20 and the cheek stimulator 30 can be adjusted in accordance with an individual difference in oral cavity volume and a preference of each of infants and young children.

### Tongue Rest

The tongue rest 40 is a protrusion connected to a rear side of the base 20. The tongue rest 40 protrudes downward and rearward from the base 20 and has a curved upper surface 40A which is recessed downward on progression toward the rear of the upper surface 40A.

A groove 42 is formed at the center of the tongue rest 40 in the width direction. The groove 42 is formed forward from a rear end (innermost end) of the tongue rest 40 and penetrates in the up-and-down direction. In a groove wall of the groove 42, a distal end portion 42A is formed in a curved surface shape and is smoothly connected to other portions.

As illustrated in FIG. 2, the tongue rest 40 has a tapered shape whose dimension W3 in the width direction gradually decreases from the front toward the rear.

### Handle

As illustrated in FIG. 1, the handle 50 is a portion that is connected to an outside of the cheek stimulator 30 and that protrudes outward (forward) from a central portion of the base 20 in the width direction. A protrusion dimension of the handle 50 from the cheek stimulator 30 is a dimension protruding from the user's oral cavity in the state where the mouthpiece 10 is fitted in the oral cavity.

As with the base 20, the handle 50 is formed in a plate shape along the XY plane and provided with a through hole 52 penetrating upper and lower surfaces. In the handle 50, a groove 54 along an outer peripheral surface of the cheek stimulator 30 is formed in an upper surface of a portion connected to the cheek stimulator 30. In the handle 50, a back surface of the groove 54 is a flat surface, and the lower lip is fixed to the flat surface.

### Functions and Effects

In the mouthpiece 10 according to the embodiment of the disclosure, the base 20 is arranged at a position sandwiched between the upper and lower gingiva in a posture of being fitted in an oral cavity of an infant or a young child who is a user. The cheek stimulator 30 protruding in the up-and-down direction is arranged at a position surrounding the outside of the base 20.

The cheek stimulator 30, therefore, comes into contact with an inside of the cheeks of the infant or the young child. As a result, the inside of the cheeks is stimulated, and movement of the cheeks is promoted. Consequently, it is possible to promote thinning of Bichat's fat pad seen in infants and young children and to increase oral cavity volume.

In a case in which the oral cavity volume is small (in other words, in a case in which the oral cavity volume cannot be appropriately increased), a capacity for food intake in the oral cavity is relatively small, and it is also difficult to retain the food once placed inside. In this case, since it is difficult to acquire chewing and swallowing skills, there is a possibility that it is difficult to take solid food in a period from 6 months after birth to around 2 and a half years of age, for example.

In a case in which the oral cavity volume is small, it might be difficult to pronounce sounds correctly. In this case, for correct pronunciation, special adjustments, such as widening the mouth sideways while speaking, might be required, which is undesirable.

In a case in which the oral cavity volume is small, there is a higher likelihood of lingual inclination of the molars, which can also affect the acquisition of chewing and swallowing skills in adulthood.

In the cheek stimulator 30, the protrusion height of the central portion 30A is smaller than the protrusion height of the end portions 30B. In the cheek stimulator 30 surrounding the outside of the base 20, the central portion 30A is a portion that interferes with the lips of the infant or the young child. For infants and young children, movement of the upper lip is generally more difficult than movement of the lower lip. By reducing the upward protrusion height of the central portion 30A, the interference between the cheek stimulator 30 and the upper lip is suppressed, and a motion of closing the upper lip is promoted to develop the muscle. Consequently, development of oral functions (for example, a function of eating with the mouth closed and a function of pronouncing sounds correctly) during growth can be promoted. As a result, for example, favorable alignment of teeth can be promoted.

By reducing the downward protrusion height of the central portion 30A, it is possible to suppress the lower lip from being pushed downward more than necessary and to hold the lower lip at a natural position where an unnecessary load does not act on the lower lip.

The oral functions of infants and young children can thus be developed by using the mouthpiece.

The central portion 30A has a shape whose protrusion height gradually decreases from the end portions 30B toward the foremost portion of the cheek stimulator 30. As compared with a shape in which the protrusion height rapidly changes, therefore, corners are less likely to occur, and discomfort is less likely to occur in the oral cavity.

In the mouthpiece 10 according to the present embodiment, the tongue rest 40 is formed behind base 20. The upper surface 40A of the tongue rest 40 is a curved surface which is recessed downward toward the rear. Infants and young children are often not good at a motion of raising the tongue, but in a case in which the tongue comes into contact with the tongue rest 40 having such a shape, the tongue tends to warp upward. The motion of raising the tongue, therefore, is supported. That is, with the mouthpiece 10, not only the motion of the cheeks of the infant or the young child but also the motion of the tongue are promoted. As a result, secretion of saliva is promoted. A function of eating and a function of speaking are also improved.

In the mouthpiece 10 according to the present embodiment, the groove 42 is formed in the central portion of the tongue rest 40 in the width direction from the rear end toward the front. The tongue tie, therefore, is easily accommodated in the groove 42. By moving the tongue with the tongue tie in contact with the groove wall, the tongue tie is extended to increase length of the tongue tie, and development of the tongue tie is promoted. Consequently, a range of motion of the tongue increases, and the oral functions such as pronunciation, chewing, swallowing, and respiration are improved.

In the groove wall of the groove 42, the distal end portion 42A is formed in a curved surface shape and is smoothly connected to other portions. Stimulation in a case in which a tip of the tongue tie comes into contact with the distal end portion 42A of the groove wall, therefore, is alleviated.

As illustrated in FIG. 2, the tongue rest 40 has a tapered shape whose width W3 gradually decreases from the front toward the rear. Discomfort in a case in which the tongue rest 40 is arranged on a back side of the tongue, therefore, is alleviated.

In the mouthpiece 10 according to the present embodiment, the base 20 and the cheek stimulator 30 are made of a flexible material. For this reason, the base 20 and the cheek stimulator 30 can be elastically deformed in a case in which the base 20 and the cheek stimulator 30 come into contact with the upper and lower gingiva or the inside of the teeth or the cheeks. As a result, the gingiva and the cheeks hardly become painful.

As indicated in FIG. 2 by arrows F1, in the case in which the base 20 and the cheek stimulator 30 are elastically deformed, the base 20 and the cheek stimulator 30 attempt to return to original shapes thereof, and stimulation is given to the inside of the cheeks to promote movement of the cheeks. As a result, the effect of promoting the thinning of Bichat's fat pad is enhanced. It is also possible to increase the oral cavity volume.

In the mouthpiece 10 according to the present embodiment, the end portions 20B of the base 20 have tapered shapes. The mouthpiece 10 is therefore inserted into the oral cavity through the thin end portions 20B. Compared to a case in which the end portions 20B are not tapered, therefore, it is easy to insert the mouthpiece 10 into the oral cavity.

As illustrated in FIG. 1, the handle 50 is connected to the mouthpiece 10 according to the present embodiment. The mouthpiece 10, therefore, can be easily inserted into the oral cavity, and easily removed from the oral cavity. Since the through hole 52 is formed in the handle 50, it is possible to suppress accidental ingestion of the mouthpiece 10 by passing a string.

In the handle 50, the groove 54 along the outer peripheral surface of the cheek stimulator 30 is formed in the upper surface of the portion connected to the cheek stimulator 30. Since the groove 54 is formed, a movable range of the upper lip can be increased as compared with a case in which the groove 54 is not provided. As a result, a motion effect of the upper lip can be enhanced.

Depth of the groove 54 is preferably as deep as possible insofar as a level of strength to the extent that the handle 50 does not come off the mouthpiece 10 can be secured.

In the mouthpiece 10 according to the present embodiment, as illustrated in FIG. 3, the downward protrusion dimension H1 of the cheek stimulator 30 is larger than the upward protrusion dimension H2. The lower jaw of humans moves downward and forward.

Since the downward protrusion dimension of the cheek stimulator is larger than the upward protrusion dimension, the state in which the cheek stimulator is in contact with the inside of the cheeks can be maintained even in a case in which the lower jaw moves downward and forward.

### Other Examples

Although the tongue rest 40 is formed behind the base 20 in the embodiment as illustrated in FIG. 1, embodiments of the disclosure are not limited thereto. For example, the tongue rest 40 need not be provided. Even in a case in which the tongue rest 40 is not provided, the motion of closing the upper lip is promoted and the oral functions of the infant or the young child can be developed insofar as the protrusion height of the central portion 30A of the cheek stimulator 30 is smaller than the protrusion height of the end portions 30B.

Even in a case in which the tongue rest 40 is provided, the groove 42 need not necessarily be provided. The tongue rest 40 need not have a tapered shape that gradually narrows from the front toward the rear. Even without these components, the effect of promoting the motion of the tongue of the infant or the young child can be obtained.

Although the mouthpiece 10 is made of an elastic material having flexibility (for example, silicone) and the base 20, the cheek stimulator 30, the tongue rest 40, and the handle 50 are made of the same material and integrally formed seamlessly in the embodiment, embodiments of the disclosure are not limited thereto.

For example, in view of manufacturing requirements, the base 20, the cheek stimulator 30, the tongue rest 40, and the handle 50 may be formed as “separate members” of the same material or different materials, and joined together by one of various methods including an adhesive, heat welding, and two-shot molding. That is, the mouthpiece 10 may be integrally formed while including seams.

Flexibility of each of the materials forming the base 20, the cheek stimulator 30, the tongue rest 40, and the handle 50 can be appropriately adjusted in accordance with the preference of the infant or the young child and functions to be developed. For example, a resin material such as a resin having no flexibility (or having less flexibility compared to silicone or the like) may be used for the formation.

In the embodiment, the end portions 20B of the base 20 have tapered shapes in which the width gradually decreases from the front toward the rear, but embodiments of the disclosure is not limited thereto. For example, even in a case in which the end portions 20B are not tapered, the oral functions of the infant or the young child can be developed.

Although the handle 50 is formed on the cheek stimulator 30 and the through hole 52 is formed in the handle 50 in the embodiment, embodiments of the disclosure are not limited thereto. For example, even in a case in which the through hole 52 is not formed, the mouthpiece 10 can be easily inserted into the oral cavity and easily removed from the oral cavity. The oral functions of the infant or the young child can be developed without forming the handle 50.

In a case in which the handle 50 is formed, the handle 50 may have any protrusion dimension from the cheek stimulator 30. Although the protrusion dimension of the handle 50 from the cheek stimulator 30 is a dimension large enough for the mouthpiece 10 to protrude from the user's oral cavity in the state where the mouthpiece 10 is fitted in the oral cavity in the embodiment, the protrusion dimension may be a dimension small enough for the mouthpiece 10 not to protrude from the oral cavity.

### Supplementary Note 1

The disclosure can include the following aspects.

### Tenth Aspect

A method of training oral functions that uses the mouthpiece according to any one of the first to ninth aspects.

### Eleventh Aspect

A method of training oral functions that uses a mouthpiece to be fitted in an oral cavity, the method including:
inserting the mouthpiece into an oral cavity of a person to be trained;
sandwiching a base of the mouthpiece formed in such a way as to be curved from a central portion on a front side toward end portions on a rear side between upper and lower gingiva or teeth; and
stimulating cheeks from the oral cavity with a cheek stimulator formed in such a way as to protrude in an up-and-down direction at a position surrounding an outside of the base and in which a protrusion height of a central portion is smaller than a protrusion height of end portions.

### Twelfth Aspect

The method of training oral functions according to the eleventh aspect, further including placing the tongue of the person to be trained on a tongue rest, which is a curved surface that is formed behind the base, that protrudes downward and rearward, and that has an upper surface recessed downward toward the rear side, to warp the tongue upward.

### Thirteenth Aspect

The method of training oral functions according to the eleventh or twelfth aspect, further including moving the tongue of the person to be trained by accommodating the tongue tie of the person to be trained in a groove formed forward in a central portion of the tongue rest in a width direction from a rear end and penetrating in the up-and-down direction.

### Supplementary Note 2

The disclosure can include the following aspects.
(((1)))

A mouthpiece including:
in a state of being fitted in an oral cavity,
a base that is formed so as to be curved, from a central portion at a front side, toward respective end portions at a rear side, and that is arrangeable at a position sandwiched between upper and lower gingiva or teeth; and
a cheek stimulator that is formed so as to protrude in an up-and-down direction, at a position surrounding an outer side of the base, and in which a protrusion height of a central portion is smaller than a protrusion height of respective end portions.
(((2)))

The mouthpiece according to (((1))), in which a tongue rest, which protrudes downward and rearward and has a curved upper surface recessed downward toward the rear side, is formed behind the base.
(((3)))

The mouthpiece according to (((2))), in which a groove, formed toward a front side from a rear end and penetrating in the up-and-down direction, is provided at a central portion
(((4)))

The mouthpiece according to any one of (((1))) to (((3))), in which the base and the cheek stimulator are formed of a flexible material.
(((5)))

The mouthpiece according to (((4))), in which the base has an elastic force directed outward in a width direction.
(((6)))

The mouthpiece according to any one of (((1))) to (((5))), in which the respective end portions of the base have tapered shapes such that width gradually decreases from the front side toward the rear side.
(((7)))

The mouthpiece according to any one of (((1))) to (((6))), in which a handle protruding outward from the central portion of the base is coupled to the cheek stimulator, and
a through hole is formed in the handle.
(((8)))

The mouthpiece according to any one of (((1))) to (((7))), in which a downward protrusion dimension of the cheek stimulator is larger than an upward protrusion dimension of the cheek stimulator.
(((9)))

The mouthpiece according to any one of (((1))) to (((8))), in which a handle protruding outward from the central portion of the base is connected to the cheek stimulator, and
a groove along an outer peripheral surface of the cheek stimulator is formed in an upper surface of a portion of the handle coupled to the cheek stimulator.

The disclosure of Japanese Patent Application No. 2022-164322 filed on Oct. 12, 2022 is incorporated herein by reference in its entirety. All documents, patent applications, and technical standards described in this specification are incorporated herein by reference to the same extent as in a case in which the individual documents, patent applications, and technical standards are specifically and individually described to be incorporated by reference.

1. A mouthpiece, comprising:
in a state of being fitted in an oral cavity,
a base that is formed so as to be curved, from a central portion at a front side, toward respective end portions at a rear side, and that is arrangeable at a position sandwiched between upper and lower gingiva or teeth; and
a cheek stimulator that is formed so as to protrude in an up-and-down direction, at a position surrounding an outer side of the base, and in which a protrusion height of a central portion is smaller than a protrusion height of respective end portions.

2. The mouthpiece according to claim 1, wherein a tongue rest, which protrudes downward and rearward and has a curved upper surface recessed downward toward the rear side, is formed behind the base.

3. The mouthpiece according to claim 2, wherein a groove, formed toward a front side from a rear end and penetrating in the up-and-down direction, is provided at a central portion of the tongue rest in a width direction.

4. The mouthpiece according to claim 1, wherein the base and the cheek stimulator are formed of a flexible material.

5. The mouthpiece according to claim 4, wherein the base has an elastic force directed outward in a width direction.

6. The mouthpiece according to claim 1, wherein the respective end portions of the base have tapered shapes such that width gradually decreases from the front side toward the rear side.

7. The mouthpiece according to claim 1, wherein:
a handle protruding outward from the central portion of the base is coupled to the cheek stimulator, and
a through hole is formed in the handle.

8. The mouthpiece according to claim 1, wherein a downward protrusion dimension of the cheek stimulator is larger than an upward protrusion dimension of the cheek stimulator.

9. The mouthpiece according to claim 1, wherein:
a handle protruding outward from the central portion of the base is connected to the cheek stimulator, and
a groove along an outer peripheral surface of the cheek stimulator is formed in an upper surface of a portion of the handle coupled to the cheek stimulator.
